(19) United States
(12) Patent Application Publication
(10) Pub. No.: US 2026/0012104 A1
(43) Pub. Date: Jan. 8, 2026

(54) POWER CONVERSION SYSTEM AND POWER CONVERSION METHOD

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Hakjun LEE, Suwon-si (KR); Hyeongyu CHOI, Incheon (KR); Junsik HWANG, Siheung-si (KR); Minseok CHAE, Gwangju (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/291,902

(22) Filed: Aug. 6, 2025

Related U.S. Application Data
(63) Continuation of application No. PCT/KR2025/006825, filed on May 20, 2025.

(30) Foreign Application Priority Data
Jul. 5, 2024 (KR) 10-2024-0089199

(51) Int. Cl. H02M 7/44; H02M 1/00

(52) U.S. Cl. CPC H02M 7/44; H02M 1/0009

(57) ABSTRACT

A power conversion system may include: a power conversion module including a plurality of switching elements, the power conversion module configured to perform a power conversion operation through the plurality of switching elements; and a controller configured to: perform a first operation of the power conversion operation to drive the plurality of switching elements in a first control cycle, the first control cycle including a first plurality of switching cycles, and based on a result of the first operation, after the first control cycle, drive the plurality of switching elements in a second control cycle, the second control cycle including a second plurality of switching cycles.

### CROSS-REFERENCE TO RELATED APPLICATIONS

This is a continuation application, under 35 U.S.C. § 111 (a), of International Application No. PCT/KR2025/006825, filed May 20, 2025, which claims priority under 35 U.S.C. § 119 to Korean Patent Application No. 10-2024-0089199, filed Jul. 5, 2024, in the Korean Intellectual Property Office, the disclosures of which are incorporated herein in their entireties by reference.

### TECHNICAL FIELD

The disclosure relates to a power conversion system and power conversion method for performing an operation to drive a plurality of switching elements in one control cycle.

### BACKGROUND ART

Power conversion may be performed by a power conversion system such as direct current to direct current (DC/DC), alternate current to direct current (AC/DC), DC/AC, AC/AC, etc. The power conversion system may include a power conversion device including a plurality of switching elements and a controller for driving the plurality of switching elements of the power conversion device, and may perform efficient power conversion by controlling driving of the plurality of switching elements of the power conversion device through the controller.

The controller requires an operation time to compute control signals to drive the plurality of switching elements. However, recently, switching devices with quick switching cycles are used to increase the power conversion efficiency, so the switching cycle is faster than the operation time of the controller, which leads to a failure of accurate control over the switching devices.

### DISCLOSURE

### Technical Problem

The disclosure may provide a power conversion system and power conversion method, by which an operation is performed to drive a plurality of switching elements in one control cycle and the plurality of switching devices are driven according to the operation result in the next control cycle to the one control cycle.

### Technical Solution

In accordance with the present disclosure, a power conversion system may include: a power conversion module including a plurality of switching elements, the power conversion module configured to perform a power conversion operation through the plurality of switching elements; and a controller configured to: perform a first operation of the power conversion operation to drive the plurality of switching elements in a first control cycle, the first control cycle including a first plurality of switching cycles, and based on a result of the first operation, after the first control cycle, drive the plurality of switching elements in a second control cycle, the second control cycle including a second plurality of switching cycles.

The power conversion system may further include: a current sensor configured to detect an output current output from the power conversion module and produce corresponding information, wherein the controller may be further configured to: based on the information produced by the current sensor in at least one switching cycle of the first plurality of switching cycles, perform at least a portion of the first operation.

The first plurality of switching cycles may include: a first switching cycle, and a plurality of second switching cycles, and the controller may be further configured to: based on the information produced by the current sensor in the first switching cycle, perform the at least the portion of the first operation to drive the plurality of switching elements in the first control cycle, wherein the first control cycle includes at least some second switching cycles of the plurality of second switching cycles.

The first switching cycle may be longer than each second switching cycle of the plurality of second switching cycles.

A start point of the first switching cycle may be equal to a start point of the first control cycle.

A middle point of the first switching cycle may be equal to a middle point of the first control cycle.

The second plurality of switching cycles may include: a third switching cycle, and a plurality of fourth switching cycles, and the controller may be further configured to: based on a result of the first operation performed in the at least some second switching cycles, perform the second operation to drive the plurality of switching elements in the second control cycle that includes the third switching cycle and the plurality of fourth switching cycles.

The controller may be further configured to: based on the information produced by the current sensor in the third switching cycle, perform the second operation to drive the plurality of switching elements in the second control cycle, the second control cycle including at least some of the plurality of fourth switching cycles.

The controller may be further configured to: based on a result of the second operation, after the second control cycle, perform a third operation of the power conversion operation to drive the plurality of switching elements in a third control cycle.

A sum of a duration of the first plurality of switching cycles may be set to be longer than a first operation cycle of the power conversion operation, or a sum of a duration of the second plurality of switching cycles may be set to be longer than a second operation cycle of the power conversion operation.

In accordance with the present disclosure, a power conversion method of a power conversion system including a power conversion module including a plurality of switching elements, the power conversion module configured to perform a power conversion operation through the plurality of switching elements, the method may include: performing a first operation of the power conversion operation to drive the plurality of switching elements in a first control cycle, the first control cycle including a first plurality of switching cycles; and based on a result of the first operation, after the first control cycle, driving the plurality of switching elements in a second control cycle.

The power conversion system may further include: a current sensor configured to detect an output current output from the power conversion module and produce corresponding information, and the performing of the first operation may include: based on the information produced by the current sensor in at least one switching cycle of the first plurality of switching cycles, performing at least a portion of the first operation.

The first plurality of switching cycles may include: a first switching cycle, and a plurality of second switching cycles, and the performing of the first operation may include: based on the information produced by the current sensor in the first switching cycle, performing the at least a portion of the first operation to drive the plurality of switching elements in the first control cycle, the first control cycle including at least some second switching cycles of the plurality of second switching cycles.

The first switching cycle may be longer than each second switching cycle of the plurality of second switching cycles.

A start point of the first switching cycle may be equal to a start point of the first control cycle.

### Advantageous Effects

According to the disclosure, even when switching elements operate in high-speed switching cycles, the driving of the switching elements may be more accurately controlled by performing an operation in one control cycle and driving the switching elements in the next control cycle.

According to the disclosure, in one control cycle, an output current flowing through a resistor element is detected in a section set to be relatively long, and a switching element is driven in a high-speed switching cycle in a section of not detecting the output current flowing through the resistor element and an operation is performed to drive the switching element, and in the next cycle to the one control cycle, the driving of the switching element may be more accurately controlled.

The effects according to the disclosure are not limited thereto, and throughout the specification it will be clearly appreciated by those of ordinary skill in the art that there may be other effects unmentioned.

### DESCRIPTION OF DRAWINGS

FIG. 1 is a diagram for describing operations between a power conversion system and various components, according to an embodiment.

FIG. 2 is a control block diagram of a power conversion system, according to an embodiment.

FIG. 3 is a diagram for describing operations between a power conversion system and various components, according to an embodiment.

FIG. 4 is a diagram for describing conventional relations between switching cycles and control cycles.

FIG. 5 is a diagram for describing problems with conventional relations between a switching cycle and a control cycle.

FIG. 6 is a diagram for describing a section in which a current sensor detects an output current, according to an embodiment.

FIG. 7 is a flowchart for describing a method of performing an operation and driving a switching element based on the operation result in a control cycle in a power conversion system, according to an embodiment.

FIG. 8 is a diagram for describing relations between control cycles and switching cycles of a power conversion system, according to an embodiment.

FIG. 9 is a diagram for describing a method of performing an operation to drive switching elements and driving the switching elements based on the operation result during multiple control cycles, according to an embodiment.

FIG. 10 is a diagram for describing a method of performing an operation to drive switching elements and driving the switching elements based on the operation result during multiple control cycles, according to an embodiment.

### MODES OF THE INVENTION

Embodiments and features as described and illustrated in the disclosure are merely examples, and there may be various modifications replacing the embodiments and drawings at the time of filing this application.

The terminology used herein is for the purpose of describing particular embodiments only and is not intended to limit the disclosure.

For example, the singular forms “a”, “an” and “the” as herein used are intended to include the plural forms as well, unless the context clearly indicates otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and

C.

The expression “and/or” is interpreted to include a combination or any of associated elements.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

Furthermore, the terms, such as “˜ part”, “˜ block”, “˜ member”, “˜ module”, etc., may refer to a unit of handling at least one function or operation. For example, the terms may refer to at least one process handled by hardware such as a field-programmable gate array (FPGA)/application specific integrated circuit (ASIC), etc., software stored in a memory, or at least one processor.

A power conversion system according to various embodiments will now be described in detail in connection with the accompanying drawings.

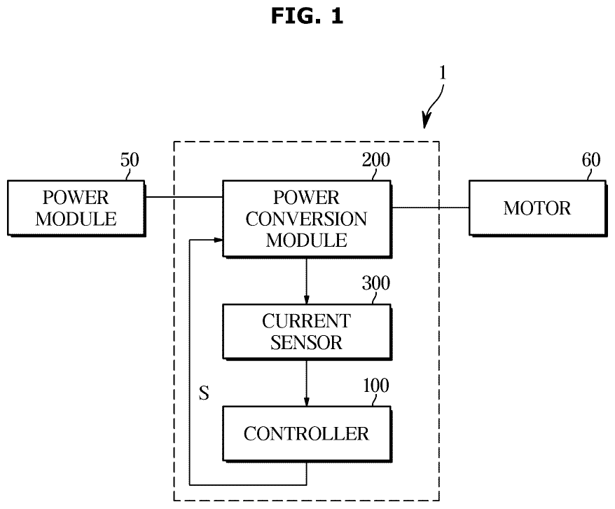

FIG. 1 is a diagram for describing operations between a power conversion system and various components, according to an embodiment.

Referring to FIG. 1, a power module 50 may supply power to a power conversion module 200. For example, the power module 50 may apply a direct current (DC) voltage to the power conversion module 200.

The power module 50 may include an EMI filter for converting an alternate current (AC) voltage applied from a commercial power source to a DC voltage and eliminating noise of the AC voltage applied from the commercial power source to apply the converted DC voltage to the power conversion module 200, a power factor circuit (PFC) for correcting a power factor of the power conversion system 1, a converter for converting the AC voltage applied from the commercial power source to a DC voltage through switching operations and/or an output capacitor across which the DC voltage is applied.

A power conversion system 1 may include the power conversion module 200, a current sensor 300 and/or a controller 100.

The power conversion module 200 may use the DC voltage applied from the power module 50 to perform a power conversion operation.

The power conversion operation may include converting the DC voltage applied from the power module 50 to an AC voltage. In this case, the power conversion module 200 may be referred to as an inverter.

The power conversion operation is not, however, limited thereto. For example, the power module 50 may apply an AC voltage to the power conversion module 200, and the power conversion operation may include converting an AC voltage applied from the power module 50 to a DC voltage. In this case, the power conversion module 200 may be referred to as a converter.

For convenience of explanation, the power conversion operation will now be described as converting a DC voltage applied from the power module 50 to an AC voltage.

The power conversion module 200 may apply an AC voltage converted through a power conversion operation to a motor 60.

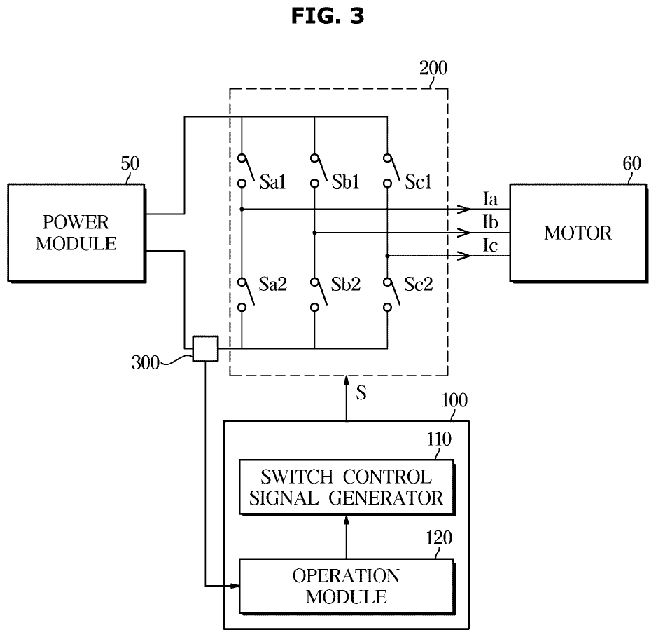

The applying of the AC voltage converted by the power conversion module 200 through the power conversion operation to the motor 60 may refer to applying, by the power conversion module 200, output currents Ia, Ib and Ic (see FIG. 3) output through the power conversion operation to the motor 60.

The current sensor 300 may detect the output currents Ia, Ib and Ic output from the power conversion module 200.

The detecting, by the current sensor 300, of the output currents Ia, Ib and Ic may include converting an analog signal output from the power conversion module 200 to a digital signal, and estimating the output currents Ia, Ib and Ic output from the power conversion module 200 from the converted digital signal.

The current sensor 300 may send information about the detected output current Ia, Ib and Ic to the controller 100. For example, the current sensor 300 may convert the analog signal output from the power conversion module 200 to a digital signal, estimate the output currents Ia, Ib and Ic output from the power conversion module 200 from the converted digital signal, and send information about the estimated output current to the controller 100.

The controller 100 may generate a control signal S based on the output currents Ia, Ib and Ic detected by the current sensor 300. The control signal refers to a switching control signal S as will be described later. For example, the controller 100 may receive information about the estimated output currents from the current sensor 300, and generate the control signal S for power conversion operation of the power conversion module 200 based on the estimated output currents.

The controller 100 may send the control signal S to the power conversion module 200, and the power conversion module 200 may perform power conversion operation according to the control signal S.

The motor 60 may be driven based on the output currents Ia, Ib and Ic applied from the power conversion module 200. The motor 60 is equipped with a stator and a rotator, and the rotator may be rotated when an AC voltage is applied to a coil on the stator.

The motor 60 may include a surface-mounted permanent magnet synchronous motor (SMPMSM), an interior permanent magnet synchronous motor (IPMSM), a synchronous reluctance motor (Synrm), etc.

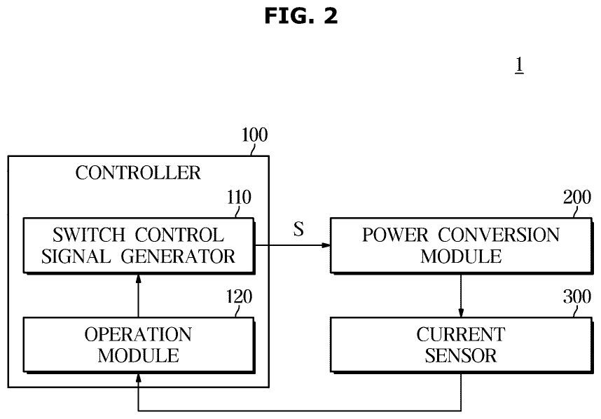

FIG. 2 is a control block diagram of a power conversion system, according to an embodiment.

The controller 100 may include a switching control signal generator 110 and/or an operation module 120.

The operation module 120 may perform an operation based on the output currents Ia, Ib and Ic detected by the current sensor 300.

The operation module 120 performing the operation may include the operation module 120 performing various operations to determine the switching control signal S to be generated by the switching control signal generator 110.

For example, the operation module 120 may obtain a voltage command to determine the switching control signal S from the output currents Ia, Ib and Ic detected by the current sensor 300, and based on the obtained voltage command, the switching control signal generator 110 may determine the switching control signal S.

The switching control signal generator 110 may generate the switching control signal S based on a result of the operation performed by the operation module 120. For example, the switching control signal generator 110 may generate the switching control signal S according to the voltage command obtained by the operation module 120 based on a space vector pulse width modulation (SVPWM) method.

The switching control signal generator S may supply the switching control signal S to the power conversion module 200. Furthermore, the switching control signal S may be converted by a gate driver (not shown) to a gate driving signal and supplied to the power conversion module 200.

The power conversion module 200 may perform power conversion operation according to the switching control signal S generated based on the output currents Ia, Ib and Ic detected by the current sensor 300, and the motor 60 may be driven according to the output currents Ia, Ib and Ic output by the power conversion operation of the power conversion module 200.

FIG. 3 is a diagram for describing operations between a power conversion system and various components, according to an embodiment.

The power conversion module 200 may include a plurality of switching elements. For example, the power conversion module 200 may include upper switching elements and lower switching elements. The upper switching elements may include a first upper switching element Sa1, a second upper switching element Sb1 and a third upper switching element Sc1. The lower switching elements may include a first lower switching element Sa2, a second lower switching element Sb2 and a third lower switching element Sc2.

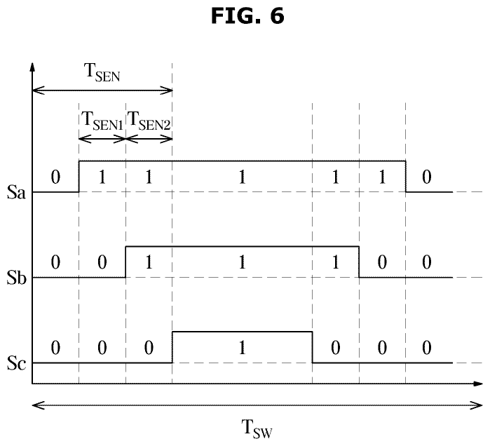

The first upper switching element Sa1 and the first lower switching element Sa2 are first phase switching elements Sa corresponding to one of three phases (see FIG. 6).

The second upper switching element Sb1 and the second lower switching element Sb2 are second phase switching elements Sb corresponding to one of the three phases (see FIG. 6).

The third upper switching element Sc1 and the third lower switching element Sc2 are third phase switching elements Sc corresponding to one of the three phases (see FIG. 6).

The first phase switching element Sa being turned on means that the first upper switching element Sa1 being turned on and the first lower switching element Sa2 being turned off. The first phase switching element Sa being turned off means that the first upper switching element Sa1 being turned off and the first lower switching element Sa2 being turned on.

The second phase switching element Sb being turned on means that the second upper switching element Sb1 being turned on and the second lower switching element Sb2 being turned off. The second phase switching element Sb being turned off means that the second upper switching element Sb1 being turned off and the second lower switching element Sb2 being turned on.

The third phase switching element Sc being turned on means that the third upper switching element Sc1 being turned on and the third lower switching element Sc2 being turned off. The third phase switching element Sc being turned off means that the third upper switching element Sc1 being turned off and the third lower switching element Sc2 being turned on.

The first output current Ia may be applied to the motor 60 in the phase connected to the first phase switching element Sa.

The second output current Ib may be applied to the motor 60 in the phase connected to the second phase switching element Sb.

The third output current Ic may be applied to the motor 60 in the phase connected to the third phase switching element Sc.

Each of the plurality of switching elements may include an IGBT switch, a GaN switch, an SiC switch, etc.

The power conversion module 200 may perform power conversion operation through the plurality of switching elements. For example, the power conversion module 200 may convert a DC voltage applied from the power module 50 according to ON/OFF operations of the plurality of switching elements to output the output currents Ia, Ib and Ic.

The current sensor 300 may be connected between the power module 50 and the power conversion module 200 to detect the output currents Ia, Ib and Ic output by the power conversion module 200.

For example, the current sensor 300 may include a single resistor element (not shown), sampling a current flowing between the power module 50 and the power conversion module 200 through the resistor element, perform analog-to-digital signal conversion (A/D conversion) on the sampled current into a digital signal, and estimate the output currents Ia, Ib and Ic from the converted digital signal.

This method may be called the 1-shunt method. The method of detecting the output currents Ia, Ib and Ic according to the disclosure is not, however, limited thereto. For example, the current sensor 300 may use the 2-shunt method or the 3-shunt method to detect the output currents Ia, Ib and Ic with two or more resistor elements (not shown).

The operation module 120 may perform an operation to drive the plurality of switching elements based on the output currents Ia, Ib and Ic detected by the current sensor 300. The switching control signal generator 110 may generate the switching control signal S for driving the plurality of switching elements based on a result of the operation to drive the plurality of elements based on the output currents Ia, Ib and Ic output by the current sensor 300.

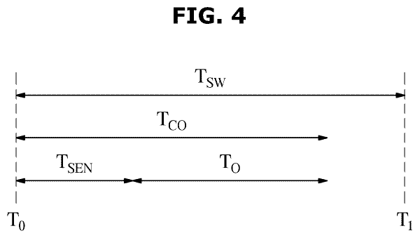

FIG. 4 is a diagram for describing conventional relations between switching cycles and control cycles.

Referring to FIG. 4, in a conventional technology, a sensing cycle Tsen for detecting the output currents Ia, Ib and Ic is started at a start point TO at which one switching cycle Tsw begins, an operation cycle To for performing an operation is started after the sensing cycle Tsen ends, and when the operation cycle To ends, driving of the switching element is controlled according to a result of the operation in a subsequent switching cycle after an end point Tl at which the switching cycle Tsw ends.

The detecting of the output currents Ia, Ib and Ic and the performing of the operation based on the output currents Ia, Ib and Ic may be referred to as a control operation, and a sum of the sensing cycle Tsen for detecting the output currents Ia, Ib and Ic and the operation cycle To required for the operation based on the output currents Ia, Ib and Ic may refer to as a control operation cycle Tco.

According to this, the control operation is performed during the switching cycle Tsw so that an operation may be performed to drive the switching element in the next switching cycle.

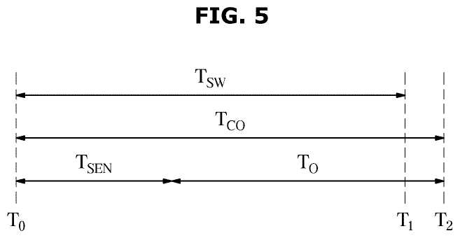

FIG. 5 is a diagram for describing problems with conventional relations between switching cycles and control cycles.

A switching element that may operate with a quick switching cycle is used to increase motor control efficiency. Hence, referring to FIG. 5, the control operation cycle Tco is longer than the switching cycle Tsw, causing a problem with a failure to perform the control operation during the switching cycle Tsw. This may make it impossible to accurately control driving of the switching element in the next switching cycle to the switching cycle Tsw. To solve this problem, there may be a way to increase the speed of the control operation, which may, however, increase the expenses of the power conversion system to increase the speed of the control operation.

FIG. 6 is a diagram for describing a section in which a current sensor detects an output current, according to an embodiment.

Referring to FIG. 6, the controller 100 may drive a plurality of switching elements for the power conversion module 200 to perform power conversion operation. For example, the controller 100 may control the first phase switching element Sa to be turned on or off in the switching cycle Tsw. The controller 100 may control the second phase switching element Sb to be turned on or off in the switching cycle Tsw. The controller 100 may control the third phase switching element Sc to be turned on or off in the switching cycle Tsw.

In FIG. 6, a section of “0” refers to one where the switching element is turned off, and a section of “1” refers to one where the switching element is turned on. For example, a section where the first phase switching element Sa is turned on is the section of “0”, and a section where the first phase switching element Sa is turned off is the section of “1”.

The current sensor 300 may detect the output currents Ia, Ib and Ic output from the power conversion module 200 in the sensing cycle Tsen.

For example, the current sensor 300 may detect at least one of the output currents Ia, Ib and Ic in a sensing cycle Tsen1 where the first phase switching element Sa is turned on, and the second phase switching element Sb and the third phase switching element Sc are turned off.

In another example, the current sensor 300 may detect at least one of the output currents Ia, Ib and Ic in a sensing cycle Tsen2 where the first phase switching element Sa and the second phase switching element Sb are turned on, and the third phase switching element Sc is turned off.

When the switching cycle Tsw is short, the current sensor 300 is unable to detect the output currents Ia, Ib and Ic in the sensing cycle Tsen, or the sensing cycle Tsen for detecting the output currents Ia, Ib and Ic may be lengthened. The sampling process may be performed after a minimum sensing time Tmin, a sum of a setting time due to a ringing phenomenon caused by the plurality of switching elements, a dead time and an A/D conversion time, and the output currents Ia, Ib and Ic may be detected according to the sampling process, but in a case that the switching cycle Tsw is short, the minimum sensing time is not secured, so the output currents Ia, Ib and Ic may not be detected or the sensing cycle Tsen may be lengthened to detect the output currents Ia, Ib and Ic.

A method that is able to control operation of the switching element even without increasing the speed of the control operation will now be described according to an embodiment.

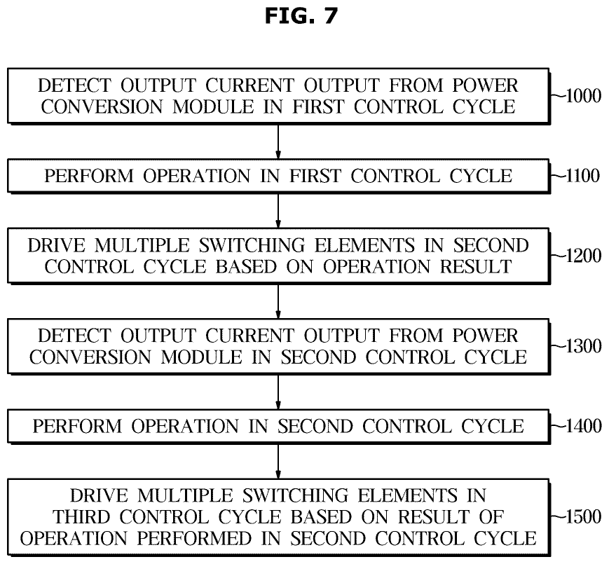

FIG. 7 is a flowchart for describing a method of performing an operation and driving a switching element based on the operation result in a control cycle of a power conversion system, according to an embodiment.

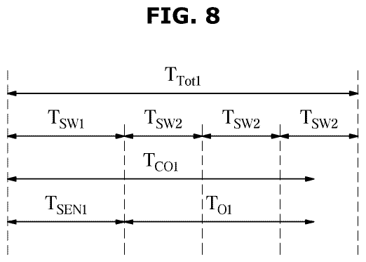

FIG. 8 is a diagram for describing relations between control cycles and switching cycles of a power conversion system, according to an embodiment.

Referring to FIGS. 7 and 8, the current sensor 300 may detect the output currents Ia, Ib and Ic output from the power conversion module 200 in a first control cycle Ttot1, in 1000. For example, the current sensor 300 may detect the output currents Ia, Ib and Ic output from the power conversion module 200 in the first sensing cycle Tsen1 of the first control cycle Ttot1.

In an embodiment, the controller 100 may perform an operation to drive the plurality of switching elements in the first control cycle Ttot1, in 1100.

For example, the controller 100 may perform an operation to drive the plurality of switching elements for an operation cycle To1 for driving the plurality of switching elements based on the output currents Ia, Ib and Ic detected by the current sensor 300 in the first sensing cycle Tsen1.

The first control cycle Ttot1 may include a plurality of switching cycles. For example, the first control cycle Ttot1 may include a first switching cycle Tsw1 and a plurality of second switching cycles Tsw2.

In an embodiment, the controller 100 may perform an operation in at least some of the plurality of second switching cycles Tsw2 based on the output currents Ia, Ib and Ic detected by the current sensor 300 in the first switching cycle Tsw1.

The first sensing cycle Tsen1 and the first switching cycle Tsw1 may be the same period. In other words, the controller 100 may control the plurality of switching elements to be driven in the first switching cycle Tsw1, and the current sensor 300 may detect the output currents Ia, Ib and Ic output from the power conversion module 200 in the first switching cycle Tsw1. Based on the output currents Ia, Ib and Ic detected by the current sensor 300 in the first switching cycle Tsw1, the controller 100 may perform an operation in at least some of the plurality of second switching cycles Tsw2 during the first operation cycle To1. A result of the operation to drive the plurality of switching elements may be obtained by the time the first control operation cycle Tco1 ends.

The second switching cycle Tsw2 may be a switching cycle, in which the switching element does not operate, according to the operation result in the first control cycle Ttot1.

The first switching cycle Tsw1 may be longer than each of the plurality of second switching cycles Tsw2. In other words, the controller 100 may set the first switching cycle Tsw1 for detecting the output currents Ia, Ib and Ic required for an operation to be long, and set each of the plurality of second switching cycles Tsw2 that are not required for the operation to be short.

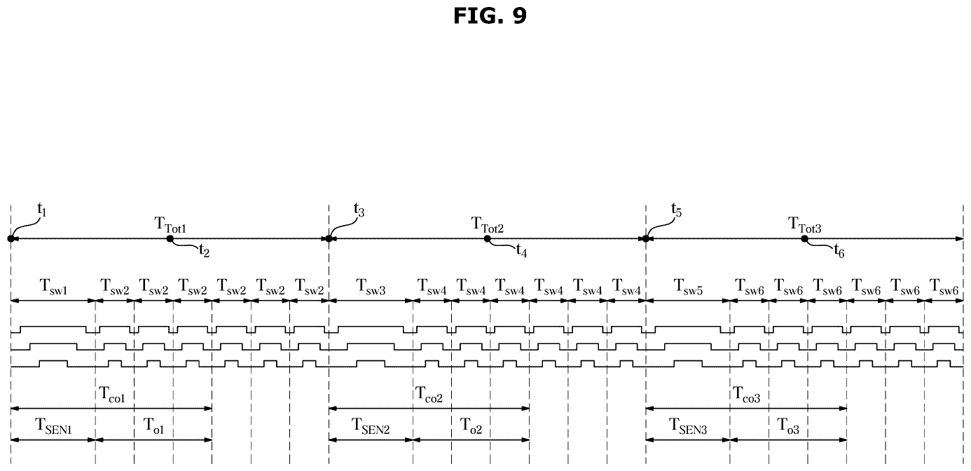

FIG. 9 is a diagram for describing a method of performing an operation to drive switching elements and driving the switching elements based on the operation result during multiple control cycles, according to an embodiment.

Referring to FIGS. 7 and 9, in an embodiment, the controller 100 may drive a plurality of switching elements in a second control cycle Ttot2 next to the first control cycle Ttot1 based on a result of the operation performed in the first control cycle Ttot1.

For example, the controller 100 may determine a length of a switching cycle, the number of switching cycles, a duty cycle of the switching element, etc., in the second control cycle Ttot2 next to the first control cycle Ttot1 based on a result of the operation performed in the first control cycle Ttot1, and drive the plurality of switching elements in the second control cycle Ttot2.

The second control cycle Ttot2 may include a third switching cycle Tsw3 and a plurality of fourth switching cycles Tsw4.

The controller 100 may drive the plurality of switching elements in the third switching cycle Tsw3 and the plurality of fourth switching cycles Tsw4 based on a result of the operation performed in the first control cycle Ttot1.

For example, the controller 100 may determine the length of each of the third switching cycle Tsw3 and the plurality of fourth switching cycles Tsw4, and the number of the plurality of fourth switching cycles Tsw4 based on the result of the operation in the first control cycle Ttot1.

Turning back to FIG. 7, the current sensor 300 may detect the output currents Ia, Ib and Ic output from the power conversion module 300 in the second control cycle Ttot2, in 1300.

Referring to FIG. 9, the current sensor 300 may detect the output currents Ia, Ib and Ic output from the power conversion module 300 in the second sensing cycle Tsen2 of the second control cycle Ttot2.

The second sensing cycle Tsen2 and the third switching cycle Tsw3 may be the same period. In other words, the controller 100 may control the plurality of switching elements to be driven in the third switching cycle Tsw3 based on the result of the operation in the first control cycle Ttot1, and the current sensor 300 may detect the output currents Ia, Ib and Ic output from the power conversion module 200 in the third switching cycle Tsw3.

The controller 100 may perform an operation in the second control cycle Ttot2, in 1400 (see FIG. 7).

The controller 100 may perform the operation based on the output currents Ia, Ib and Ic detected by the current sensor 300 in the third switching cycle Tsw3. For example, the controller 100 may perform the operation in a second operation cycle To2 required for the operation in at least some of the plurality of fourth switching cycles Tsw4 based on the output currents Ia, Ib and Ic detected by the current sensor 300 in the third switching cycle Tsw3.

In an embodiment, the controller 100 may control the plurality of switching elements to be driven in the third switching cycle Tsw3 having the same start point as a start point t3 of the second control cycle Ttot2.

The current sensor 300 may detect the output currents Ia, Ib and Ic output from the power conversion module 200 in a third switching cycle Tsw3 having the same start point as the start point t3 of the second control cycle Ttot2. In other words, the current sensor 300 may detect the output currents Ia, Ib and Ic output from the power conversion module 200 from the start point of the second control cycle Ttot2.

A result of the operation to drive the plurality of switching elements in the second control cycle Ttot2 may be obtained by the time the second control operation cycle Tco2 ends.

The third switching cycle Tsw3 may be longer than each of the plurality of fourth switching cycles Tsw4. In other words, the controller 100 may set the third switching cycle Tsw3 for detecting the output currents Ia, Ib and Ic required for an operation to be long, and set each of the plurality of fourth switching cycles Tsw4 that are not required for the operation to be short.

The controller 100 may drive the plurality of switching elements in the third control cycle Ttot3 based on the result of the operation performed in the second control cycle Ttot2, in 1500 (see FIG. 7).

For example, the controller 100 may determine length of the switching cycle, the number of switching cycles, a duty cycle of the switching element, etc., in the third control cycle Ttot3 next to the second control cycle Ttot2 based on a result of an operation performed in the second control cycle Ttot2, and drive the plurality of switching elements in the third control cycle Ttot3.

The third control cycle Ttot3 may include a fifth switching cycle Tsw5 and a plurality of sixth switching cycles Tsw6.

The controller 100 may drive the plurality of switching elements in the fifth switching cycle Tsw5 and the plurality of sixth switching cycles Tsw6 based on a result of the operation performed in the second control cycle Ttot2.

For example, the controller 100 may determine the length of each of the fifth switching cycle Tsw5 and the plurality of sixth switching cycles Tsw6, and the number of the plurality of sixth switching cycles Tsw6 based on the result of the operation in the second control cycle Ttot2.

In the third control cycle Ttot3, the current sensor 300 may detect the output currents Ia, Ib and Ic output from the power conversion module 300.

For example, the current sensor 300 may detect the output currents Ia, Ib and Ic output from the power conversion module 300 in the third sensing cycle Tsen3 of the third control cycle Ttot3.

The third sensing cycle Tsen3 and the fifth switching cycle Tsw5 may be the same period. In other words, the controller 100 may control the plurality of switching elements to be driven in the fifth switching cycle Tsw5 based on the result of the operation in the second control cycle Ttot2, and the current sensor 300 may detect the output currents Ia, Ib and Ic output from the power conversion module 200 in the fifth switching cycle Tsw5.

The controller 100 may perform an operation in the third control cycle Ttot3.

The controller 100 may perform the operation based on the output currents Ia, Ib and Ic detected by the current sensor 300 in the fifth switching cycle Tsw5. For example, the controller 100 may perform the operation in a third operation cycle To3 required for the operation in at least some of the plurality of sixth switching cycles Tsw6 based on the output currents Ia, Ib and Ic detected by the current sensor 300 in the fifth switching cycle Tsw5.

In an embodiment, the controller 100 may control the plurality of switching elements to be driven in the fifth switching cycle Tsw5 having the same start point as the start point t5 of the third control cycle Ttot3.

The current sensor 300 may detect the output currents Ia, Ib and Ic output from the power conversion module 200 in the fifth switching cycle Tsw5 having the same start point as the start point t5 of the third control cycle Ttot3. In other words, the current sensor 300 may detect the output currents Ia, Ib and Ic output from the power conversion module 200 from the start point of the third control cycle Ttot3.

A result of the operation to drive the plurality of switching elements in the third control cycle Ttot3 may be obtained by the time the third control operation cycle Tco3 ends.

The fifth switching cycle Tsw5 may be longer than each of the plurality of sixth switching cycles Tsw6. In other words, the controller 100 may set the fifth switching cycle Tsw5 for detecting the output currents Ia, Ib and Ic required for an operation to be long, and set each of the plurality of sixth switching cycles Tsw6 that are not required for the operation to be short.

In an embodiment, the controller 100 may set a sum of the plurality of switching cycles to be longer than an operation cycle required for the operation.

For example, in the first control cycle Ttot1, the controller 100 may set a sum of the first switching cycle Tsw1 and the plurality of second switching cycles Tsw2 to be longer than the first operation cycle To1.

In another example, in the second control cycle Ttot2, the controller 100 may set a sum of the third switching cycle Tsw3 and the plurality of fourth switching cycles Tsw4 to be longer than the second operation cycle To2.

For example, in the third control cycle Ttot3, the controller 100 may set a sum of the fifth switching cycle Tsw5 and the plurality of sixth switching cycles Tsw6 to be longer than the third operation cycle To3.

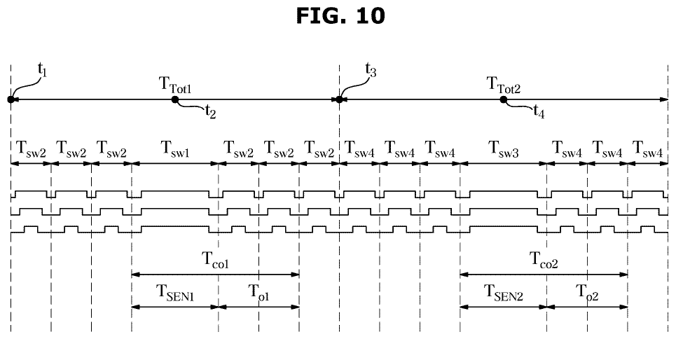

FIG. 10 is a diagram for describing a method of performing an operation to drive switching elements and driving the switching elements based on the operation result during multiple control cycles, according to an embodiment.

In an embodiment, the controller 100 may control the plurality of switching elements to be driven in the first switching cycle Tsw1 having a start point equal to a middle point t2 of the first control cycle Ttot1.

The current sensor 300 may detect the output currents Ia, Ib and Ic output from the power conversion module 200 in the first switching cycle Tsw1 having the same middle point as the middle point t2 of the first control cycle Ttot1. In other words, the current sensor 300 may detect the output currents Ia, Ib and Ic output from the power conversion module 200 in a section including the middle point t2 of the first control cycle Ttot1.

In an embodiment, the controller 100 may control the plurality of switching elements to be driven in the third switching cycle Tsw3 having a start point equal to a middle point t4 of the second control cycle Ttot2.

The current sensor 300 may detect the output currents Ia, Ib and Ic output from the power conversion module 200 in the third switching cycle Tsw3 having the same middle point as the middle point t4 of the second control cycle Ttol1. In other words, the current sensor 300 may detect the output currents Ia, Ib and Ic output from the power conversion module 200 in a section including the middle point t4 of the second control cycle Ttot2.

According to the disclosure, a better effect is gained to increase power conversion efficiency by performing an operation in one control cycle and then driving switching elements that perform switching operations with high-speed switching cycles by reflecting a result of the operation, in the next control cycle.

According to an embodiment of the disclosure, a power conversion system includes a power conversion module configured to include a plurality of switching elements and perform power conversion operation through the plurality of switching elements; and a controller configured to perform an operation to drive the plurality of switching elements in a first control cycle, and drive the plurality of switching elements based on a result of the operation in a second control cycle next to the first control cycle, wherein the first control cycle and the second control cycle each include a plurality of switching cycles.

The power conversion system may further include a current sensor configured to detect an output current output from the power conversion module, and the controller may be configured to perform an operation based on the output current detected by the current sensor in the first control cycle.

The first control cycle may include a first switching cycle and a plurality of second switching cycles, and the controller may be configured to perform an operation in at least some of the plurality of second switching cycles based on the output current detected by the current sensor in the first switching cycle.

The first switching cycle may be longer than each of the plurality of second switching cycles.

A start point of the first switching cycle may be equal to a start point of the first control cycle.

A middle point of the first switching cycle may be equal to a middle point of the first control cycle.

The second control cycle may include a third switching cycle and a plurality of fourth switching cycles, and the controller may be configured to control the plurality of switching elements in the third switching cycle and the plurality of fourth switching cycles based on a result of the operation performed in at least some of the plurality of second switching cycles.

The controller may be configured to perform an operation in at least some of the plurality of fourth switching cycles based on the output current detected by the current sensor in the third switching cycle.

The controller may be configured to drive the plurality of switching elements in a third control cycle next to the second control cycle based on the result of the operation performed in the second control cycle.

A sum of the plurality of switching cycles may be set to be longer than an operation cycle required for an operation.

According to an embodiment of the disclosure, a power conversion method using a plurality of switching elements includes performing an operation to drive the plurality of switching elements in a first control cycle; and driving the plurality of switching elements in a second control cycle next to the first control cycle based on a result of the operation, wherein the first control cycle and the second control cycle may each include a plurality of switching cycles.

The performing of the operation in the first control cycle may include performing the operation based on an output current output from the plurality of switching elements in the first control cycle.

The first control cycle may include a first switching cycle and a plurality of second switching cycles, and the performing of the operation in the first control cycle may include performing the operation based on an output current output from the plurality of switching elements in the first switching cycle.

The first switching cycle may be longer than each of the plurality of second switching cycles.

A start point of the first switching cycle may be equal to a start point of the first control cycle.

A middle point of the first switching cycle may be equal to a middle point of the first control cycle.

The second control cycle may include a third switching cycle and a plurality of fourth switching cycles, and the driving of the plurality of switching elements in the second control cycle based on a result of the operation may include driving the plurality of switching elements in the third switching cycle and the plurality of fourth switching cycles based on a result of the operation performed in at least some of the plurality of second switching cycles.

The power conversion method may further include performing an operation in at least some of the plurality of fourth switching cycles based on the output current output from the plurality of switching elements in the third switching cycle.

The power conversion method may further include driving the plurality of switching elements in a third control cycle next to the second control cycle based on the result of the operation performed in the second control cycle.

A sum of the plurality of switching cycles may be set to be longer than an operation cycle required for an operation.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a recording medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a recording medium that may be readable to a device such as a server of the manufacturer, a server of the application store, or a relay server.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

1. A power conversion system comprising:
a power conversion module including a plurality of switching elements, the power conversion module configured to perform a power conversion operation through the plurality of switching elements; and
a controller configured to:
perform a first operation of the power conversion operation to drive the plurality of switching elements in a first control cycle, the first control cycle including a first plurality of switching cycles, and
based on a result of the first operation, after the first control cycle, drive the plurality of switching elements in a second control cycle, the second control cycle including a second plurality of switching cycles.

2. The power conversion system of claim 1, further comprising:
a current sensor configured to detect an output current output from the power conversion module and produce corresponding information,
wherein the controller is further configured to:
based on the information produced by the current sensor in at least one switching cycle of the first plurality of switching cycles, perform at least a portion of the first operation.

3. The power conversion system of claim 2, wherein:
the first plurality of switching cycles includes:
a first switching cycle, and
a plurality of second switching cycles, and
the controller is further configured to:
based on the information produced by the current sensor in the first switching cycle, perform the at least the portion of the first operation to drive the plurality of switching elements in the first control cycle,
wherein the first control cycle includes at least some second switching cycles of the plurality of second switching cycles.

4. The power conversion system of claim 3, wherein the first switching cycle is longer than each second switching cycle of the plurality of second switching cycles.

5. The power conversion system of claim 3, wherein a start point of the first switching cycle is equal to a start point of the first control cycle.

6. The power conversion system of claim 3, wherein a middle point of the first switching cycle is equal to a middle point of the first control cycle.

7. The power conversion system of claim 3, wherein:
the second plurality of switching cycles includes:
a third switching cycle, and
a plurality of fourth switching cycles, and
the controller is further configured to:
based on a result of the first operation performed in the at least some second switching cycles, perform the second operation to drive the plurality of switching elements in the second control cycle that includes the third switching cycle and the plurality of fourth switching cycles.

8. The power conversion system of claim 7, wherein
the controller is further configured to:
based on the information produced by the current sensor in the third switching cycle, perform the second operation to drive the plurality of switching elements in the second control cycle, the second control cycle including at least some of the plurality of fourth switching cycles.

9. The power conversion system of claim 8, wherein
the controller is further configured to:
based on a result of the second operation, after the second control cycle, perform a third operation of the power conversion operation to drive the plurality of switching elements in a third control cycle.

10. The power conversion system of claim 1, wherein
a sum of a duration of the first plurality of switching cycles is set to be longer than a first operation cycle of the power conversion operation, or
a sum of a duration of the second plurality of switching cycles is set to be longer than a second operation cycle of the power conversion operation.

11. A power conversion method of a power conversion system including a power conversion module including a plurality of switching elements, the power conversion module configured to perform a power conversion operation through the plurality of switching elements, the method comprising:
performing a first operation of the power conversion operation to drive the plurality of switching elements in a first control cycle, the first control cycle including a first plurality of switching cycles; and
based on a result of the first operation, after the first control cycle, driving the plurality of switching elements in a second control cycle.

12. The power conversion method of claim 11, wherein
the power conversion system further includes:
a current sensor configured to detect an output current output from the power conversion module and produce corresponding information, and
the performing of the first operation includes:
based on the information produced by the current sensor in at least one switching cycle of the first plurality of switching cycles, performing at least a portion of the first operation.

13. The power conversion method of claim 12, wherein:
the first plurality of switching cycles includes:
a first switching cycle, and
a plurality of second switching cycles, and
the performing of the first operation includes:
based on the information produced by the current sensor in the first switching cycle, performing the at least a portion of the first operation to drive the plurality of switching elements in the first control cycle, the first control cycle including at least some second switching cycles of the plurality of second switching cycles.

14. The power conversion method of claim 13, wherein the first switching cycle is longer than each second switching cycle of the plurality of second switching cycles.

15. The power conversion method of claim 13, wherein a start point of the first switching cycle is equal to a start point of the first control cycle.
